(19) United States
(12) Patent Application Publication
(10) Pub. No.: US 2025/0072664 A1
(43) Pub. Date: Mar. 6, 2025

(54) CONTACT TOASTER WITH BELT

(71) Applicant: STEARNS PRODUCT DEVELOPMENT CORPORATION, Perris, CA (US)

(72) Inventors: Howard Frantz, Irvine, CA (US); Juan Martinez, Menifee, CA (US)

(21) Appl. No.: 18/817,805

(22) Filed: Aug. 28, 2024

Related U.S. Application Data
(60) Provisional application No. 63/535,547, filed on Aug. 30, 2023.

(51) Int. Cl. A47J 37/08

(52) U.S. Cl. CPC A47J 37/0857; A47J 37/0864

(57) ABSTRACT

A conveyorized contact toaster includes a toasting platen having a planar toasting surface and a belt assembly configured to interface with a food item to urge the food item against and along the planar toasting surface. The belt assembly includes a belt body having a first end portion, a second end portion, an inner surface, and an opposing outer surface. A first belt connector is coupled to the first end portion of the belt body, and a second belt connector is coupled to the second end portion of the belt body. The belt body is configurable in a loop configuration with the first end portion being positioned adjacent the second end portion, and the first belt connector detachably coupled to the second belt connector to maintain the belt body in the loop configuration.

### CROSS-REFERENCE TO RELATED APPLICATIONS

This application claims the benefit of U.S. Provisional Application Ser. No. 63/535,547, filed Aug. 30, 2023, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to toasters, and more specifically to conveyorized contact toasters having a plurality of independently compressible resilient gripping elements capable of accommodating buns that vary in thickness.

### 2. Description of the Related Art

There are two primary techniques for toasting bread: radiation and conduction. Radiant toasters are primarily used for toasting sliced bread, muffins, and bagels. Conventional radiant toasters include one or more heat elements positioned to toast one or both sides of the bread. The radiant emissions tend to penetrate the bread to create a crunchy, deep toasted layer. Radiant toasters may be static, such as the typical household toaster, or dynamic, such as a toaster having rotating conveyers, commonly used in restaurants.

Contact toasters are commonly used for toasting burger buns in many quick-service restaurants. Rather than creating a deep, crunchy toast, contact toasters typically create a thin, caramelized layer that may serve as a barrier or impediment to moisture or sauces from penetrating into the bun to prevent sogginess. Many contact toasters are vertically oriented and configured to allow for insertion of the bun from the top, with the bun exiting the toaster from the bottom after having been toasted. In many contact toasters, a rotating conveyer moves a bun across a hot platen to allow the heat from the platen to toast the bun. The rotating conveyer is spaced from the hot platen by a gap to accommodate the thickness of the bun.

In the past, many restaurants used to use one bun size on all of the hamburgers and cheeseburgers offered by the restaurant. However, over time, restaurants began to offer standard burgers, as well as premium burgers associated with thicker buns. The proliferation of various bun sizes has become common in the restaurant industry, which has led to several manners of dealing with the variations of bun thickness in terms of toasting the buns.

One particular manner of dealing with variable bun thickness is to utilize a single gap setting across all bun thicknesses. In particular, the gap between the conveyer and the platen is set to one thickness and is used for all bun types and thicknesses. This usually involves a compromise as thicker buns may be more compressed when passing through the toaster, while thinner buns may receive only minor compression. The amount of compression may impact the rate of heat transfer and the resultant quality of the toasted bun. Accordingly, adopting a single gap setting may result in an undesirable variable toast quality depending on the thickness of the bun.

Another manner of dealing with the variable bun thickness is to continually reset the gap to accommodate buns of different thickness. While continual resetting of the gap may provide optimal gap sizing for each bun, it is oftentimes impractical to customize the gap for each bun. Typically, buns are toasted to order, and thus, one particular order may include buns of several different thicknesses. Any restaurant with a high volume of food orders may not be able to customize the gap size for each bun.

Yet another manner of dealing with variable bun thickness is to have a separate toaster for each bun type, with each toaster having a unique gap size. However, the bun toaster may be a part of a highly engineered production line, where space on the line is precious. Furthermore, the toasters may be associated with high cost, and thus, adding toasters may not be a practical solution.

Certain contact toasters have attempted to address the issue of varying bun thicknesses by incorporating compressible gripping elements that extend from a main belt body, with the compressible gripping elements being configured to interface with the bun. The degree to which the gripping elements flex or compress depends on the thickness of the bun, with thicker buns causing a greater degree of flexion than thinner buns. However, the gripping elements may undesirably puncture or deform the buns as they interface with the buns.

Another deficiency associated with conventional contact toasters is that only one surface of the bun receives an appreciable amount of heat (e.g., the surface of the bun in contact with the toasting platen). Thus, the surface of the bun opposite the toasting platen oftentimes may remain much cooler than the toasted surface, which may be undesirable. Rather, a more preferred result is a bun having a less drastic temperature difference throughout the bun.

Conventional contact toasters also require regular cleaning of the conveyor belt, which typically requires removal of the conveyor belt from a conveyor drive mechanism. Conventional conveyor belts employ one of two common modalities for removably attaching to the drive mechanism. A first modality is a zipper style modality, which is used on a belt having two opposed ends that can be attached to each other such that the belt forms a loop. Several small teeth may be located at each end of the belt. To connect the belt, the teeth may be aligned in a prescribed configuration, and a metal rod may be inserted between the teeth to connect the two ends. This process tends to be very tedious, and thus, the belt may not be cleaned as often as it should. The second modality is one that utilizes a metal chain, on which the silicone belt is placed. However, the metal chain typically requires more space and requires a bigger motor, which increases the overall cost.

Accordingly, there is a need in the art for a contact toaster than can accommodate buns that vary in thickness, while addressing the deficiencies noted above. Various aspects of the present disclosure address this particular need, as will be discussed in more detail below.

### BRIEF SUMMARY

In accordance with one embodiment of the present disclosure, there is provided a conveyorized contact toaster comprising a toasting platen having a planar toasting surface and a belt assembly configured to interface with a food item to urge the food item against and along the planar toasting surface. The belt assembly includes a belt body having a first end portion, a second end portion, an inner surface, and an opposing outer surface. A first belt connector is coupled to the first end portion of the belt body, and a second belt connector is coupled to the second end portion of the belt body. The belt body is configurable in a loop configuration with the first end portion being positioned adjacent the second end portion, and the first belt connector detachably coupled to the second belt connector to maintain the belt body in the loop configuration.

One of the first and second belt connectors may include a hook and the other of the first and second belt connectors may include a ring configured to be selectively connectable to the hook.

The conveyorized contact toaster may additionally include a first stiffener at the first end portion of the belt body and a second stiffener at the second end portion of the belt body. The first stiffener and the second stiffener may be more resistant to bending than the belt body. The first stiffener and the second stiffener may be internal to the belt body, or alternatively, the first stiffener and the second stiffener may be external to the belt body.

The belt assembly may additionally include a plurality of gripping bodies extending from the belt body, with the gripping bodies being configured to interface with the food item. The gripping bodies may extend at a non-perpendicular angle relative to the belt body when the gripping body is not interfacing with the food item. Each gripping body may be fixedly attached to the belt body and is resiliently flexible relative to the belt body.

The conveyorized contact toaster may additionally include a gripping body heat platen configured to apply heat to the gripping bodies. The gripping body heat platen may be configured to apply heat to the gripping bodies via conduction.

According to another embodiment, there is provided a conveyorized contact toaster comprising a toasting platen having a planar toasting surface and a belt assembly configured to interface with a food item to urge the food item against and along the planar toasting surface. The belt assembly includes a belt body being configurable in a loop configuration. A plurality of gripping bodies extend from the belt body, with the gripping bodies being configured to interface with the food item. The gripping bodies extend at a non-perpendicular angle relative to the belt body when the gripping body is not interfacing with the food item.

According to another embodiment, there is provided a heated conveyor mechanism for a contact toaster including a toasting platen having a planar toasting surface. The heated conveyor mechanism includes a belt assembly configured to interface with a food item to urge the food item against and along the planar toasting surface. The belt assembly includes a belt body being configurable in a loop configuration, and a plurality of gripping bodies extending from the belt body, with the gripping bodies being configured to interface with the food item. The heated conveyor mechanism additionally includes a gripping body heat platen separate from the toasting platen and configured to emit heat. The gripping body heat platen is positionable adjacent the belt assembly such that the gripping bodies are disposable in contact with the gripping body heat platen to facilitate heat transfer from the gripping body heat platen to the gripping bodies.

The gripping bodies may extend at a non-perpendicular angle relative to the belt body when the gripping body is not interfacing with the food item.

The belt body may include a first end portion and a second end portion connectable to the first end portion to assume the loop configuration. The belt assembly additionally includes a first stiffener at the first end portion of the belt body and a second stiffener at the second end portion of the belt body, the first stiffener and the second stiffener being more resistant to bending than the belt body.

The belt body, when in the loop configuration, may define a bun interface portion and a return portion. The bun interface portion may be juxtaposed to the planar toasting surface and the return portion may be juxtaposed to the gripping body heat platen.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a side view of a conveyorized contact toaster having a plurality of angled gripping bodies for pressing and moving a bun along a toasting surface, and a gripping body heat platen for heating the gripping bodies prior to interfacing with the buns;

FIG. 2 is partial side view of a belt assembly included in the conveyorized contact toaster of FIG. 1;

FIG. 3 is a partial front view of the belt assembly of FIG. 2;

FIG. 4 is a partial enlarged side view of the belt assembly interfacing with a bun to urge the bun against and along the toasting platen;

FIG. 5 is an upper perspective view of the belt body having first and second belt connectors coupled thereto;

FIG. 6 is an enlarged view of first and second belt connectors engaged with each other;

FIG. 7 is an enlarged view of the first and second belt connectors disengaged with each other;

FIG. 8 is a cross sectional view of the belt body having internal stiffeners at respective end portions thereof;

FIG. 9 is a cross sectional view of the belt body having external stiffeners at respective end portions thereof; and

FIG. 10 is a side view of the belt body in a loop configuration disposed around a pair of pulleys.

Common reference numerals are used throughout the drawings and the detailed description to indicate the same elements.

### DETAILED DESCRIPTION

The detailed description set forth below in connection with the appended drawings is intended as a description of certain embodiments of a conveyorized toaster and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to conveyorized toasters capable of more effectively toasting items, such as hamburger buns, relative to conventional conveyorized toasters. In more detail, the conveyorized toaster described herein may include a belt assembly configured for easy disassembly from a belt-drive mechanism, as well as easy re-assembly to the belt-drive mechanism. The quick and easy disassembly and re-assembly may facilitate routine cleaning and maintenance of the belt drive assembly, which may increase the effectiveness and lifespan of the belt assembly, and may also provide for a more sanitary food product.

The conveyorized toaster may additionally, or alternatively, include gripping bodies extending from a main body of the belt assembly at a non-perpendicular angle to enable gripping of the food item to urge the food item against and along a heat platen, while minimizing damage to the food item.

The conveyorized toaster may additionally, or alternatively, include an auxiliary heat platen to pre-heat the gripping bodies prior to the gripping bodies interfacing with the food item. Thus, while a primary heat platen may toast one side of the food item, the pre-heated gripping bodies may transfer heat to an opposite side of the food item. Thus, by applying heat to opposite sides of the food item, the food item may be, to a certain degree, warm throughout the food item, rather than simply being toasted on one side.

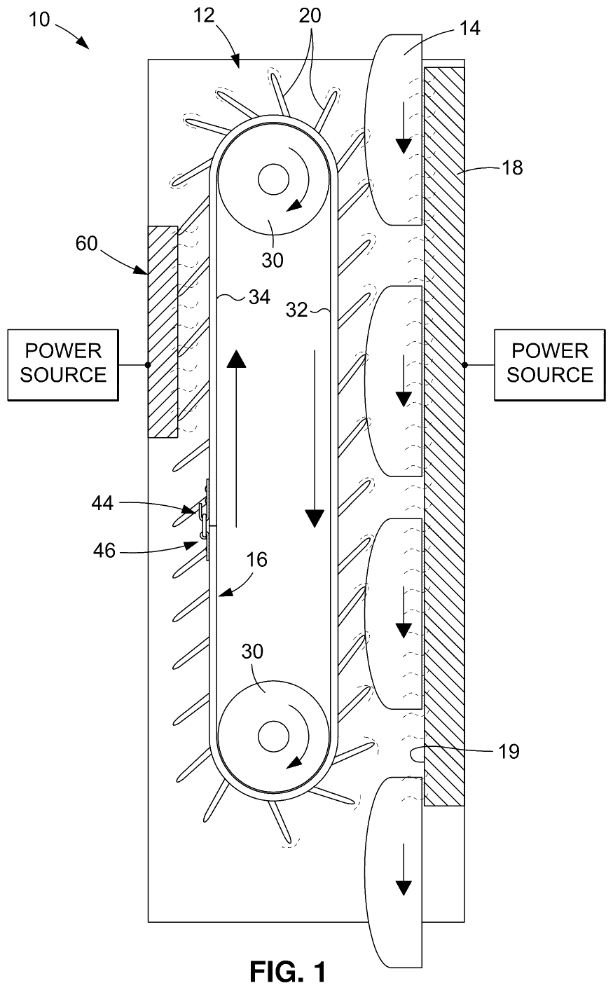

Referring now specifically to the drawings, wherein the showings are for purposes of illustrating preferred embodiments of the present disclosure, and are not for purposes of limiting the same, FIG. 1 shows an embodiment of a conveyorized toaster 10 having a belt assembly 12 for toasting hamburger buns 14 or other food items. The belt assembly 12 includes a belt body 16 spaced from the toasting platen 18 to allow hamburger bun halves (e.g., “buns”) 14 to be received between the belt body 16 and the toasting platen 18 to toast the buns 14.

FIG. 1 depicts a side view of the toaster 10 with multiple bun halves 14 positioned between the toasting platen 18 and the belt assembly 12. It is contemplated that the toaster 10 may include a housing, though in FIG. 1, no housing is depicted for purposes of clarity. The toasting platen 18 includes a planar toasting surface 19 which may be heated to toast the surface of each bun 14 that is in direct, abutting contact therewith. The toasting surface 19 may include a polytetrafluoroethylene (PTFE) exterior to allow each bun to slide smoothly over the toasting surface 19. It is also contemplated that the toasting surface may be covered by a PTFE sheet that can be removed for cleaning or replacement. The toasting platen 18 may be connected to an electrical power source, such as an electrical outlet or a battery to provide the power that may be required to heat the toasting surface 19.

The belt assembly 12 may additionally include a plurality of resilient gripping bodies 20 arranged in a prescribed pattern and configured to engage with the bun 14. The gripping bodies 20 and the belt body 16 may be integrally formed with each other, such as being formed from a common mold. The gripping bodies 20 are independently compressible to automatically adjust to the thickness of the bun 14 to apply sufficient pressure on the bun for achieving desired toasting of the bun 14 by the toasting platen 18. Engagement between the gripping bodies 20 and the bun 14 also results in the bun 14 being dragged along the platen 18 from an upper end portion to a lower end portion. The configuration and resiliency of the gripping bodies 20 may accommodate buns 14 that vary in thickness rather than relying on a one size fits all approach. In this regard, the toaster 10 may not require adjustment or resizing of the distance separating the platen 18 and the belt assembly 12 when toasting the buns 14 having different thickness. Therefore, the toaster 10 may be capable of generating higher throughput than conventional toasters while at the same time providing more consistent bun toast across all bun thicknesses. Though the bun 14 is described above as being a hamburger bun, those of ordinary skill in the art will recognize that the toaster 10 as outfitted with those unique structural features described in more detail below may be adapted for use in conjunction with different food products or items for which toasting on one surface may be desirable, such as hot dog buns, bagels, tortillas, other non-bread products, etc.

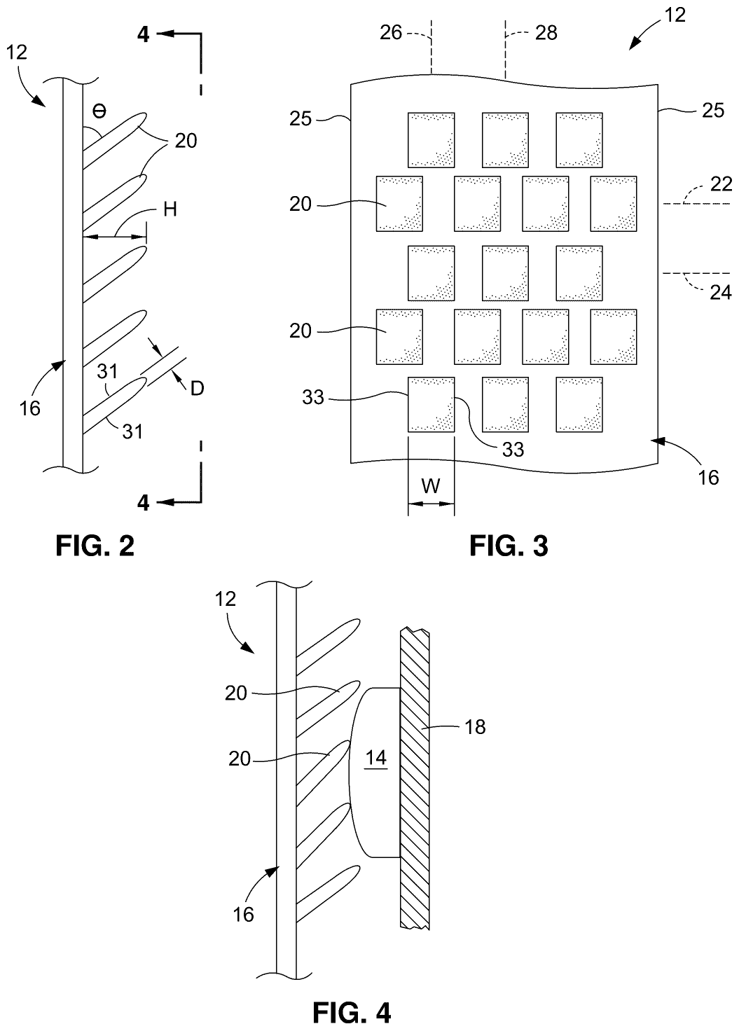

In one particular embodiment, the gripping bodies 20 extend at a non-perpendicular angle relative to an exposed surface of the belt body 16 when not interfacing with a bun 14 (e.g., in a neutral state). This particular configuration may mitigate puncturing or deforming the buns 14 as the gripping bodies 20 engage with the buns 14 and assume a flexed state. The problem of puncturing may be particularly relevant in the case of the crown half (e.g., the top half) buns 14. The angle Q (see FIG. 2) at which the gripping bodies 20 may extend from the belt body 16 may be between 45-75 degrees, and in a particular embodiment, may be 60 degrees. However, the gripping bodies 20 may extend at other angles without departing from the spirit and scope of the present disclosure. Moreover, to further reduce the chances or puncturing or marking the buns 14, the tip of each gripping body 20 may be rounded to reduce sharp edges on the gripping body 20.

The plurality of gripping bodies 20 protrude or extend from the belt body 16 and may be sized and configured such that at least one, and preferably multiple gripping bodies 20, will interface with any given bun 14 to evenly distribute the pressure applied to the bun 14. The gripping bodies 20 may be molded, formed or otherwise provided in any one of a multiplicity of different shapes and sizes. Along these lines, the gripping bodies 20 included on the belt body 16 may all be of the same size and shape, or possibly provided in prescribed combinations of differing size and/or shape. Further, the gripping bodies 20 may be molded directly onto the belt body 16 to minimize loose pieces or extra hardware, though they may alternatively comprise separate structures joined to the belt body 16 through the use of a prescribed attachment modality (e.g., an adhesive). Each gripping body 20 may be compressible (and capable of resiliently returning to its uncompressed state) independent of the adjacent gripping bodies 20 to allow the gripping bodies 20 to conform to the bun 14, i.e., each gripping body 20 may be resilient to apply a gripping force on the bun 14 when the gripping body 20 engages with the bun 14 and is compressed by the bun 14. The independent, resilient compressibility may result in evenly distributed pressure on the bun 14 to achieve uniform toasting of the bun 14, regardless of the orientation of the belt body 16. Another benefit is that even distribution of the pressure may result in greater preservation of bun integrity as the bun 14 passes through the toaster 10.

The gripping bodies 20 may be formed from a high temperature, FDA grade silicone, which may be very durable, yet lightweight. Silicone may be capable of withstanding heat, may be food-safe and easily cleanable, and is widely used in the food service industry. Silicone may also have sufficient internal resilience to generate a spring-like force when compressed. In this regard, the spring-like force may not be dependent on gravity and may be generated independent of the orientation of the toaster 10 (e.g., horizontal or vertical), which may allow for maximum flexibility in the design of the toaster 10.

Although silicone is explicitly mentioned as a possible material for the gripping bodies 20, it is contemplated that other suitable food-safe materials known by those skilled in the art may also be used to form the gripping bodies 20 without departing from the spirit and scope of the present disclosure.

According to one embodiment, and referring now to FIG. 3, the gripping bodies 20 may be positioned along a plurality of gripping row axes 22, 24, and a plurality of gripping column axes 26, 28. Each gripping row axis 22, 24 may extend orthogonal to a pair of lateral edges 25 of the belt body 16, while each gripping column axes 26, 28 may extend parallel to the pair of lateral edges 25. Although FIG. 3 only explicitly identifies gripping row axes 22, 24 and gripping column axes 26, 28, it is understood that each row of gripping bodies 20 on FIG. 3 is associated with a respective gripping row axis, and each column of gripping bodies 20 on FIG. 3 is associated with a respective gripping column axis. One or more of the gripping row axes 22, 24 and gripping column axes 26, 28 may include multiple gripping bodies 20 residing thereon or aligned therewith, with those gripping bodies 20 residing any corresponding gripping row axis 22, 24 or gripping column axis 26, 28 being arranged in spaced relation to each other. Having multiple gripping row axes 22, 24 and gripping column axes 26, 28, and multiple gripping bodies 20 on each gripping axis 22, 24, 26, 28 allows for automatic adjustment of the gripping bodies 20 to the unique contours and thicknesses of the buns 14 and provides uniform pressure against the bun 14. According to one embodiment, the width of each gripping body 20 (e.g., the dimension perpendicular to the lateral edges 25 of the belt body 16) may be less than half of the width of the belt body 16 (i.e., the distance between the lateral edges 25). In another embodiment, the width of each gripping body 20 is less than one-third or one-quarter of the width of the belt body 16.

In one implementation, each gripping body 20 may be in the shape of a fin protruding from the belt body 16. Referring to FIGS. 2 and 3, each fin may include a pair of opposed primary faces 31 defining a fin depth D therebetween and a pair of opposed side faces 33 defining a fin width W therebetween, with the fin width W being greater than the fin depth D. The fins may be positioned on the belt body 16 such that the primary faces 31 are extend generally perpendicular to the lateral edges 25, which may allow for easier deflection of the fins in a direction parallel to the lateral edges 25 in response to engagement with a bun 14. It is contemplated that the distance separating the distal edge of each fin (i.e., the edge disposed furthest from the belt body 16) from the belt body 16 will define the effective height H of each fin. It is further contemplated that the height H of all the fins included on the belt assembly 12 may be uniform, though they could be varied in some prescribed pattern or arrangement without departing from the spirit and scope of the present disclosure. Such height(s) H will also be selected to optimize the performance of the toaster 10, i.e., the efficacy/efficiency of the toasting procedure.

The fins may be hollow to allow for easier compression when engaging with the bun 14, although it is understood that the fins may also be solid without departing from the spirit and scope of the present disclosure.

Although the foregoing describes the gripping bodies 20 being in the shape of fins, it is understood that the scope of the present disclosure is not limited thereto. For instance, the gripping bodies 20 may be in the form of bristles, nubs, fingers, or other projecting structures known by those skilled in the art.

Referring back to FIG. 1, the belt assembly 12 may include a spaced pair of pulleys 30 operatively coupled to the belt body 16 such that the belt body 16 may be disposed around the pair of pulleys 30 in a loop configuration. At any point in its rotational position, the belt body 16 may define both a bun interface portion 32 and a return portion 34. The bun interface portion 32 refers to that portion of the belt body 16 extending between the pulleys 30 and juxtaposed relation to the planar toaster surface, and the return portion 34 refers to that portion of the belt body 16 extending between the pulleys 30 that is further spaced from the planar toasting surface 19 than the bun interface portion 32, i.e., the bun interface portion 32 resides between the outer return portion 34 and the toasting surface 19. From the perspective shown in FIG. 1, the bun interface portion 32 moves in a downward direction, while the outer return portion 34 moves in an upward direction as will be readily recognized by those of ordinary skill in the art during rotation of the belt body 16 about the pulleys 30, any part of the bun interface portion 32 that rotates over the lower one of the two pulleys 30 transitions the return portion 34, while any part of the return portion 34 that rotates over the upper one of the two pulleys 30 transitions the bun interface portion 32. The pulleys 30 may be positioned in opposed relation to each other in a vertical orientation, e.g., vertically spaced apart from each other and aligned along a common vertical axis. Each pulley 30 may rotate about our respective rotational axis in a similar rotational direction. From the perspective shown in FIG. 1, the pulleys 30 rotate in a clockwise direction to impart the desired motion of the belt body 16 to move the buns 14 from the top of the toasting surface 19 to the bottom of the toasting surface 19. Rotation of the pulleys 30 may be set to achieve a desired speed of bun 14 travel over the toasting surface 19. The belt body 16 may include an opposed pair of lateral edges 25 and may be routed around the pulleys 30 to assume the looped configuration or profile. The pulleys 30 may be spaced to create sufficient tension within the belt body 16.

The vertical orientation of the belt assembly 12 may prevent the weight of the belt assembly 12 from being used to create pressure on the bun 14. Certain conventional contact toasters are configured in a horizontal configuration, or in the weight of the toaster is used to create pressure on the buns 14 when toasting. Such conventional horizontal contact toasters tend to be very heavy to achieve sufficient pressure on the buns 14. The added weight tends to make the conventional toasters cumbersome and difficult to clean and maintain. In contrast, the toaster 10 may be configured such that pressure applied to the bun 14 may not be imparted by the weight of the belt assembly 12, and instead may be imparted by the resiliency and configuration of the gripping bodies 20. As such, the toaster 10 may be lighter and easier to clean and maintain than conventional toasters.

Although the exemplary embodiment is configured in a vertical orientation, it is contemplated that other implementations of the toaster 10 are not limited thereto. In this regard, the belt assembly 12 may be oriented at a 45° angle relative to a vertical axis, or alternatively, and a horizontal configuration, e.g., perpendicular to the force of gravity, or at any angle there between.

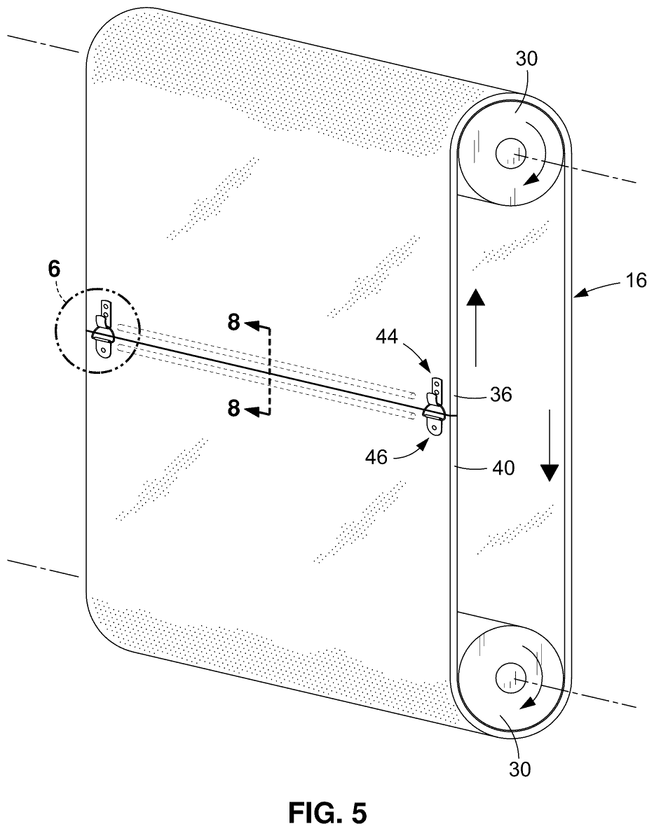

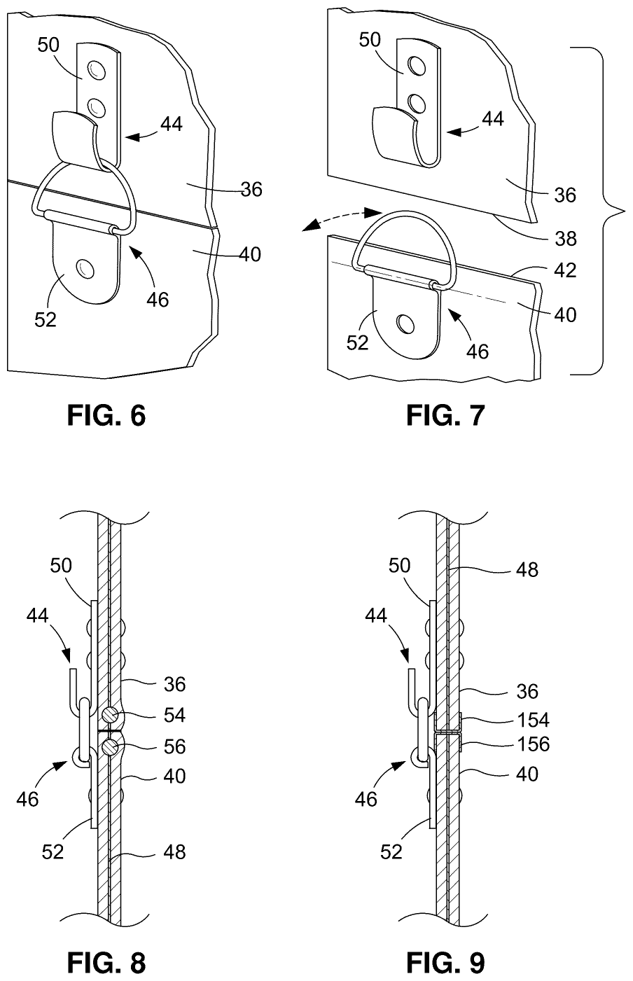

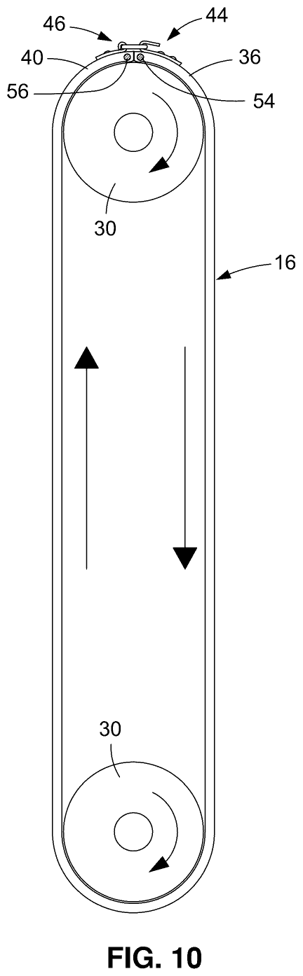

Referring now specifically to FIG. 5, there is depicted an upper perspective view of the belt body 16 with the gripping bodies 20 having been removed for purposes of clarity. According to one embodiment, the belt assembly 12 may be configured such that the belt body 16 may be configured for quick and easy removal from the pulleys 30, which may be required for routine cleaning and maintenance of the belt assembly 12. In this regard, the belt assembly 12, when disconnected from the pulleys 30, may be flattened out into a sheet having a first end portion 36 defining a first terminal edge 38 (see FIG. 7) and a second end portion 40 defining a second terminal edge 42 (see FIG. 7). A first belt connector 44 may be connected to the first end portion 36 adjacent the first terminal edge 38, while a second belt connector 46 may be connected to the second end portion 40 adjacent the second terminal edge 42. The first and second belt connectors 44, 46 may be configured to be detachably connectable to each other to facilitate arrangement of the belt body 16 in the loop configuration. In one particular implementation, one of the first and second belt connectors 44, 46 is a hook and the other of the first and second belt connectors 44, 46 is a ring configured to be selectively connectable to the hook. The belt assembly 12 may include a pair of hooks at one end portion, with each hook being adjacent a lateral edge of the belt body 16, and a pair of rings/loops at the other end portion, with each ring being adjacent a lateral edge of the belt body 16. To dispose the belt body 16 in the loop configuration, the belt body 16 is routed around the pulleys, with the first and second belt connectors 44, 46 being on an outside surface of the belt body 16 so as to avoid contact with the pulleys 30. The first and second terminal edges 38, 42 are moved close to each other, which brings the first and second belt connectors 44, 46 (e.g., rings and loops) into close proximity to each other. The hooks and rings 44, 46 may be manipulated to achieve operative engagement therebetween. In this regard, the hooks may be advanced into the rings. In this regard, the rings may be pivotable relative to the belt body 16 about a pivot axis to facilitate engagement between the rings and the hooks. The pivotal motion of the rings may also facilitate motion of the belt assembly 12 around the pulleys 30, as the position of the hooks and rings 44, 46 varies as the hooks and rings 44, 46 travel around the pulleys. Thus, the pivotal motion accounts for the change in position of the hook 44 relative to the corresponding ring 46. Once the first and second belt connectors 44, 46 are connected, the pulleys 30 may be slightly adjusted to increase tension in the belt body 16, and to tighten the connection between the first and second belt connectors 44, 46.

To disconnect the belt assembly 12 from the pulleys 30, the pulleys 30 may be adjusted to reduce the tension in the belt assembly 12 to allow the first and second belt connectors 44, 46 to be disconnected from each other. For instance, the rings may be removed from the hooks. Once the first and second belt connectors 44, 46 are detached, the belt body 16 may be removed from the pulleys 30.

It is contemplated that the belt body 16 may include an internal, core layer 48 (see FIG. 8), such as a plastic or fiberglass mesh, which is covered by a softer, external layer, such as silicone or the like. The first and second belt connectors 44, 46 may be secured to the internal, core layer 48 to enhance the connection between the belt connectors 44, 46 and the belt body 16 to mitigate unwanted ripping or detachment of the belt connectors 44, 46 from the belt body 16. For instance, each belt connector 44, 46 may include a flange 50, 52 adapted to receive a rivet or other mechanical fastener that extends through the internal, core layer 48. It is also contemplated that the flange 50, 52 may be molded directly into the belt body 16.

The toaster 10 may further include a first stiffener 54, 154 at the first end portion 36 of the belt body 16 and a second stiffener 56, 156 at the second end portion 40 of the belt body 16. The first stiffener 54, 154 and the second stiffener 56, 156 may both be formed of a material more resistant to bending than the belt body 16. For instance, the stiffeners 54, 154, 56, 156 may be formed from metal, while the belt body 16 may be formed from silicone. In one embodiment, the stiffeners 54, 56 are internal to the belt body 16. As shown in FIG. 8, the stiffeners 54, 56 may be molded into the belt body 16. As shown in FIG. 9, the stiffeners 154, 156 may be external to the belt body 16. In this regard, each stiffener 154, 156 may include a first segment that extends over one surface of the belt body 16, a second segment that extends over an opposing surface of the belt body 16, and an intermediate segment that extends over and end surface or edge of the belt body 16, with the intermediate segment extending between the first and second segments. The external stiffeners 154, 156 may be crimped or otherwise bent to facilitate retention to the belt body 16. It is also contemplated that the external stiffeners 154, 156 may be adhered to the belt body 16 or secured via mechanical fasteners, such as rivets or the like.

Referring back to FIG. 1, the toaster 10 may additionally include a gripping body heat platen 60 configured to apply heat to the gripping bodies 20 just before the gripping bodies 20 engage with the bun. The gripping body heat platen 60 may be connected to a power source and may be configured to generate heat when supplied with power from the power source. The heat generated by the gripping body heat platen 60 may be transferred to the passing gripping bodies 20 by conduction through contact of the gripping bodies 20 on the gripping body heat platen 60. The gripping body heat platen 60 may be positioned near an end of the return portion 34 of the belt body 16, with an exposed surface of the gripping body heat platen 60 being disposed in opposed relation to the exposed surface of the toasting platen 18. The size and shape of the gripping body heat platen 60 may be suitable to enable sufficient contact as to surface area and duration between the gripping bodies 20 and the gripping body heat platen 60 to transfer sufficient heat to the gripping bodies 20 while the gripping bodies 20 are in contact with the heat platen 60. Furthermore, the rate of heat transfer between the heat platen 60 and the gripping bodies 20 may be a factor in the operation of the belt assembly 12. For instance, the speed of the belt assembly 12 may be reduced as the heat platen 60 is warming up to allow for greater duration of contact between the gripping bodies 20 and the heat platen 60 to enable suitable heat transfer to the gripping bodies 20. However, once the heat platen 60 has reached a prescribed temperature associated with a greater rate of heat transfer to the gripping bodies 20, the speed of the belt assembly 12 may be increased. Thus, the toaster 10 may include a controller which monitors the temperature of the heat platen 60 and modifies the speed of the belt assembly 12, via the speed of the pulleys 30, based on the temperature of the heat platen 60.

When a bun 14 is inserted into the toaster 10, the bun 14 may be inserted into the top of the toaster 10 between the belt body 16 and the toasting surface 19, with the inside, flat surface of the bun 14 facing the toasting surface 19. The belt body 16 may rotate to bring a plurality of gripping bodies 20 into engagement with the bun 14. As each gripping body 20 engages with the bun 14, the gripping body 20 will become compressed to accommodate the thickness of the bun 14. The degree to which each gripping body 20 is compressed will depend on the thickness of the bun 14. In greater detail, a thicker bun 14 will cause a greater degree of compression of the gripping body 20 than a thinner bun 14. The compression of the gripping bodies 20 imparts a pressure on the bun 14 against the toasting surface 19, while also transferring heat from the gripping body 20 to the portion of the bun 14 interfacing with the gripping body 20. As the belt body 16 rotates, the gripping bodies 20 drag the buns 16 along the toasting surface 19 from the top end portion toward the bottom end portion. As the bun 14 is dragged along the toasting surface 19, the portion of the bun 14 in direct contact with the toasting surface 19 becomes toasted, while the opposing side of the bun 14 becomes warmer from the heat received via the gripping bodies 20. The bun 14 continues being dragged in the downward motion, until it passes the bottom edge of the toasting surface 19, wherein the bun 14 is released from being captured between the belt body 16 and the toasting platen 18 and may fall to an underlying a basket or tray for retrieval. Thus, after passing through the toaster 10, the bun 14 includes a toasted surface and an opposed warmed surface.

The conveyorized contact toaster 10 described herein may be specifically configured and adapted for use within a highly constrained restaurant environment. In this regard, the toaster 10 may be durable and have minimal small parts that could fall into a customer's food. Furthermore, all materials used that could contact the food may be listed as food safe by the United States Food and Drug Administration (FDA), the National Sanitation Foundation (NSF) and the Underwriters' Laboratories (UL). The materials may be able to tolerate high ambient temperatures associated with the toasting process.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A conveyorized contact toaster comprising:
a toasting platen having a planar toasting surface; and
a belt assembly configured to interface with a food item to urge the food item against and along the planar toasting surface, the belt assembly having:
a belt body having a first end portion, a second end portion, an inner surface, an opposing outer surface;
a first belt connector coupled to the first end portion of the belt body; and
a second belt connector coupled to the second end portion of the belt body;
the belt body being configurable in a loop configuration with the first end portion being positioned adjacent the second end portion, and the first belt connector detachably coupled to the second belt connector to maintain the belt body in the loop configuration.

2. The conveyorized contact toaster recited in claim 1, wherein one of the first and second belt connectors includes a hook and the other of the first and second belt connectors includes a ring configured to be selectively connectable to the hook.

3. The conveyorized contact toaster recited in claim 1, further comprising a first stiffener at the first end portion of the belt body and a second stiffener at the second end portion of the belt body, the first stiffener and the second stiffener being more resistant to bending than the belt body.

4. The conveyorized contact toaster recited in claim 3, wherein the first stiffener and the second stiffener are internal to the belt body.

5. The conveyorized contact toaster recited in claim 3, wherein the first stiffener and the second stiffener are external to the belt body.

6. The conveyorized contact toaster recited in claim 1, wherein the belt assembly additionally includes a plurality of gripping bodies extending from the belt body, the gripping bodies being configured to interface with the food item.

7. The conveyorized contact toaster recited in claim 6, wherein the gripping bodies extend at a non-perpendicular angle relative to the belt body when the gripping body is not interfacing with the food item.

8. The conveyorized contact toaster recited in claim 6, further comprising a gripping body heat platen configured to apply heat to the gripping bodies.

9. The conveyorized contact toaster recited in claim 8, wherein the gripping body heat platen is configured to apply heat to the gripping bodies via conduction.

10. The conveyorized contact toaster recited in claim 6, wherein each gripping body is fixedly attached to the belt body and is resiliently flexible relative to the belt body.

11. A conveyorized contact toaster comprising:
a toasting platen having a planar toasting surface; and
a belt assembly configured to interface with a food item to urge the food item against and along the planar toasting surface, the belt assembly having:
a belt body being configurable in a loop configuration; and
a plurality of gripping bodies extending from the belt body, the gripping bodies being configured to interface with the food item, the gripping bodies extend at a non-perpendicular angle relative to the belt body when the gripping body is not interfacing with the food item.

12. The conveyorized contact toaster recited in claim 11, wherein the belt body includes a first end portion and a second end portion connectable to the first end portion to assume the loop configuration, the belt assembly further comprising a first stiffener at the first end portion of the belt body and a second stiffener at the second end portion of the belt body, the first stiffener and the second stiffener being more resistant to bending than the belt body.

13. The conveyorized contact toaster recited in claim 12, wherein the first stiffener and the second stiffener are internal to the belt body.

14. The conveyorized contact toaster recited in claim 12, wherein the first stiffener and the second stiffener are external to the belt body.

15. A heated conveyor mechanism for a contact toaster including a toasting platen having a planar toasting surface, the heated conveyor mechanism comprising:
a belt assembly configured to interface with a food item to urge the food item against and along the planar toasting surface, the belt assembly having:
a belt body being configurable in a loop configuration; and
a plurality of gripping bodies extending from the belt body, the gripping bodies being configured to interface with the food item; and
a gripping body heat platen separate from the toasting platen and configured to emit heat, the gripping body heat platen being positionable adjacent the belt assembly such that the gripping bodies are disposable in contact with the gripping body heat platen to facilitate heat transfer from the gripping body heat platen to the gripping bodies.

16. The heated conveyor mechanism of claim 15, wherein the gripping bodies extend at a non-perpendicular angle relative to the belt body when the gripping body is not interfacing with the food item.

17. The heated conveyor mechanism of claim 15 wherein the belt body includes a first end portion and a second end portion connectable to the first end portion to assume the loop configuration, the belt assembly further comprising a first stiffener at the first end portion of the belt body and a second stiffener at the second end portion of the belt body, the first stiffener and the second stiffener being more resistant to bending than the belt body.

18. The heated conveyor mechanism recited in claim 17, wherein the first stiffener and the second stiffener are internal to the belt body.

19. The heated conveyor mechanism recited in claim 17, wherein the first stiffener and the second stiffener are external to the belt body.

20. The heated conveyor mechanism recited in claim 15, wherein the belt body, when in the loop configuration, defines a bun interface portion and a return portion, the bun interface portion being juxtaposed to the planar toasting surface and the return portion being juxtaposed the gripping body heat platen.
